(19) United States
(12) Patent Application Publication
(10) Pub. No.: US 2007/0272629 A1
(43) Pub. Date: Nov. 29, 2007

(54) Customizable organizer

(76) Inventor: Karen Spirer, White Plains, NY (US)

Correspondence Address: THELEN REID BROWN RAYSMAN & STEINER LLP, PO BOX 1510, NEW YORK, NY, 10150-1510, US

(21) Appl. No.: 11/440,693

(22) Filed: May 24, 2006

(51) Int. Cl. B42F 17/00

(52) U.S. Cl. 211/10

(57) ABSTRACT

The present invention generally relates to a caddy, space saver, container or organizer for holding various objects such as implements, tools, gadgets, consumables, etc., typically related to a specific or particular utility, field of endeavor or environment, e.g., kitchen, computer or desk work space (e.g., home office, children's room), garden, shop or workplace, bathroom, baby room, bedroom (e.g., dressing table), etc. Organizer embodiments are provided that are customizable for various environments and/or customizable within an environment. Customizable organizers may be provided by combinations of a base and various components (e.g., receptacles, compartments, racks, hooks, tabs, implements, containers, parts, etc.) that can be attached to the base, detachably, e.g., at the factory, at retail or by a consumer, or permanently, e.g., at the factory. Detachable components that may be used with the same or different organizers to provide the organizers with aspects of modularity and interchangeability.

### COPYRIGHT NOTICE

A portion of the disclosure of this patent document contains material, which may be subject to copyright protection. The copyright owner has no objection to the facsimile reproduction by anyone of the patent document or the patent disclosures, as it appears in the Patent and Trademark Office patent files or records, but otherwise reserves all copyright rights whatsoever.

### BACKGROUND OF THE INVENTION

The present invention generally relates to a caddy, space saver, container or organizer for holding various objects such as implements, tools, gadgets, consumables, etc., typically related to a specific or particular utility, environment or field of endeavor (hereinafter referred to as “environment”), e.g., kitchen, computer or desk work space (e.g., home office, children's room), garden, shop or workplace, bathroom, baby room, baby changing table, bedroom (e.g., dressing table), sewing, cosmetics, house cleaning, etc. According to embodiments of the invention, organizers are provided that are customizable for various environments and/or customizable within an environment.

### SUMMARY OF THE INVENTION

Organizers provided in accordance with embodiments of the invention are customizable for various environments and/or customizable within an environment. Customized organizers in accordance with embodiments of the invention may be provided by combinations of a base and various components (e.g., receptacles, compartments, racks, hooks, tabs, implements, containers, parts, etc.) that can be attached to the base, detachably, e.g., at the factory, at retail or by a consumer, or permanently, e.g., at the factory. For example, a particular base can accommodate various components, which provides for various configurations or organizers from a base or bases and a set of components. This provides aspects of modularity and dynamism to an organizer or organizers. The components may be configured for a particular environment or organizer type and also may be usable with organizers for another environment or environments. The ability to install the same component on different organizers and to remove and install different components on the same organizer or different organizers provides an aspect of interchangeability.

Embodiments of organizers may have various sizes and shapes and may include a base and one or more detachable components, each of which may be fabricated, or made, in a variety of materials including, but not limited to, plastic, metal, wood, aluminum, glass, or other material. In some embodiments, the base is rotatable relative to a supporting surface such as a countertop and may be implemented using a lazy Susan or other arrangement. The detachable components may be mounted to the organizer in various ways with various fasteners and/or parts. The detachable components may be of different shapes and sizes, and have specific or general utility. For example, a kitchen organizer may include components for holding spice jars, bulk condiments, plastic wraps, foils, recipes, timers, thermometers and/or other kitchen utensil or other kitchen related items. A bathroom organizer may include receptacle or space for a tissue box, and containers or drawers for other items, such as cotton balls and cotton swabs, or components for holding medicines or cosmetics.

Embodiments of organizers may be portable, and for large or small organizers, may include wheels similar to arrangements for luggage, and carrying cases made of various materials including, but not limited to materials such as, cloth fabric, synthetic materials, plastic, waterproof, insulated, flame retardant, etc., may be provided for the organizers, with wheels being attached to the carrying case for large or small organizers. Some embodiments of organizers may be an apron-based organizer which comprise a wearable apron constructed of various materials, such as the aforementioned carrying case materials. The apron includes one or more of the latching devices further described herein for affixing organizer components, such as oven gloves or mitts, utensils, timer, or other component, to the apron. Some organizer embodiments may have components that are electrically operated by battery or other power source, such as electronic devices, e.g., kitchen timers, radios, clocks, lights, calculators, thermometers, or other electronic device. A detachable component, which may be designed for a specific utility in a specific environment, or for general utility may be used with organizers designed for another environment. For example, a spice rack for a kitchen organizer may attach to a bathroom organizer for use with tubular shaped items, or a cotton ball holder for a bathroom organizer may attach to a baby changing table organizer, etc. Thus, according to embodiments of the invention, one or more organizer components may be interchanged from organizer to organizer.

Embodiments of organizers comprise one or more anchors or frames attached to the base, preferably, permanently, but need not be. One or more components are attached to the anchor, exclusively or predominately, detachably or permanently. An anchor may comprise a single unitary structure, or two or more separate structures which may be attached to one another to form, e.g., a composite structure.

In detachable embodiments, a mounting structure is associated with an anchor (and/or base) and/or the one or more components to detachably mount a component to the base. Such mounting structure may include fasteners and parts of various kinds including, but not limited to, hook and loop structures, mating projections and receptacles (including blind and open holes), snap on structures, hooks, releasable adhesives, etc. The mounting structure is suitably positioned and configured so that a plurality of components may be mounted to organizers.

An anchor may be configured to provide additional functionality. For example, an anchor may be configured to receive certain items or objects depending on the environment of use, e.g. a hook or pin may be provided on which, e.g., keys, jewelry may be suspended, and/or an anchor may be configured to define a space or compartment for receiving items, etc.

Embodiments of organizers including a base and an anchor are typically, but not necessarily, customized for a particular environment. For example, an embodiment of a kitchen organizer may comprise a disk-like base, preferably including a stationary part that supports the organizer from a flat surface such as a kitchen counter, shelf or table, and a part preferably rotatably mounted thereto in a lazy-Susan fashion. An upwardly, e.g., vertically extending anchor, typically having a cross-sectional area substantially less than that of the base, is mounted to the base, preferably, but not necessarily, permanently, and in the case of a base having a rotatable part, to the rotatable part. For example, the anchor may have a rectangular cross section, e.g., equal in length to the diameter of the base, or a circular cross section. The base may be provided in different sizes for the same environment or field, e.g., small, medium and large.

Embodiments of organizers may comprise various components attached to the anchor, preferably detachably, so that the organizer may be customized after leaving the factory, using interchangeable or common components, as well as parts fashioned for a specific environment. In such embodiments, a stripped down, or partially outfitted organizer may be provided separately from various components that later may be attached to the stripped down or partially outfitted organizer. For example, a stripped down, or various versions of partially outfitted organizers, may be sold at retail separately from other components that may be attached to further outfit the organizer, as selected by a particular consumer.

In an embodiment of a kitchen organizer, such components may comprise: one or more upwardly, e.g., vertically-extending structures, e.g., of tubular configuration, attached to an anchor for receiving, e.g., kitchen foils and/or wraps; one or more open-ended compartments, e.g., of tubular or rectangular cross section, extending from the anchor for receiving, e.g., spice jars or recipe cards or other thin and flat objects; open-ended compartments upwardly extending from the base for receiving, e.g., various implements. Such organizers are customizable in that in one embodiment tubular compartments may be provided for spice jars and in another embodiment rectangular compartments are provided for recipe cards, etc. In another embodiment, a component may be provided with narrow slots for receiving, e.g., notes, knives, photos or other items.

In embodiments of the invention that provide for detachable mounting of various components, consumers may select components to customize the organizer for their own use. In one embodiment, all components, with the possible exception, e.g., of the anchor(s), may be detachably mounted. In other embodiments, some components may be permanently mounted and others detachably mounted.

In embodiments of the invention which provide for permanent attachment of parts, customization is made at the factory where a number of versions of an organizer for a particular environment may be fabricated.

Embodiments of organizers may be provided for use in many other environments, and may vary in size depending upon the intended environment, and different sizes may be provided for any particular environment. Similarly, the number and size of modular or interchangeable components may vary.

### BRIEF DESCRIPTION OF THE DRAWINGS

Exemplary embodiments of the present invention are described below with reference to the following drawings, in which the same or similar references refer to the same, similar or corresponding parts.

FIG. 1 is a perspective view of an organizer according to one embodiment of the invention showing a base and anchor of the organizer.

FIG. 2 is a perspective view of the organizer depicted in FIG. 1 from the opposite side adapted for use in a kitchen environment, including a foil holder component and a top component for the anchor detachably mounted to the side and top, respectively, of the anchor.

FIG. 3 is a perspective view of the organizer depicted in FIG. 2 viewed from the opposite side showing lids detachably mounted on the tops of tubes of the foil holder.

FIG. 4 is a side perspective view of the organizer depicted in FIG. 3, additionally including a spice jar rack and a storage bin detachably mounted to the side of the anchor opposite to the one to which the foil holder is mounted.

FIG. 5 is a top perspective view of the organizer depicted in FIG. 4, additionally including wedge-shaped storage bins detachably mounted to the same side of the anchor as the spice jar rack.

FIG. 6 is a side perspective view of the organizer depicted in FIG. 2 including a rack with bins for recipes and the like instead of a spice jar rack.

FIG. 7 is a side perspective view of an accessory stand according to an embodiment of the invention.

FIG. 8 is a side perspective view of the accessory stand depicted in FIG. 7 with the spice jar rack depicted in FIG. 4 detachably mounted to one side of the anchor of the stand and the storage bin depicted in FIG. 4 detachably mounted on the other side of the anchor.

FIG. 9 is a perspective view of the organizer and components depicted in FIGS. 1-6, with the foil holders attached and the other components detached.

FIG. 10 is a perspective view, from one side, of a base and anchor of an organizer according to another embodiment of the invention.

FIG. 11 is a side perspective view of the organizer depicted in FIG. 10 including components mounted on opposite sides of the anchor.

FIG. 12 is a top perspective view of the organizer depicted in FIG. 11.

FIG. 13 is a side view of the organizer depicted in FIG. 11.

FIG. 14 is a side perspective view of the organizer depicted in FIG. 11 from the opposite side.

FIG. 15 is an exploded perspective view of the organizer and components depicted in FIGS. 10-14 showing the components depicted in FIGS. 11-14, and additional components including an additional base.

### DETAILED DESCRIPTION OF PREFERRED EMBODIMENTS

Described below are exemplary embodiments of customizable kitchen organizers, as illustrated in the drawings, which can be customizable for a wide variety of specific uses. However, organizers as disclosed herein, including the organizer depicted in the drawings, may be configured and used in various environments, for example, as pointed out above. The illustrated embodiments are exemplary and are provided for illustrative purposes only, and are not intended to limit the invention as encompassed by the claims of this application.

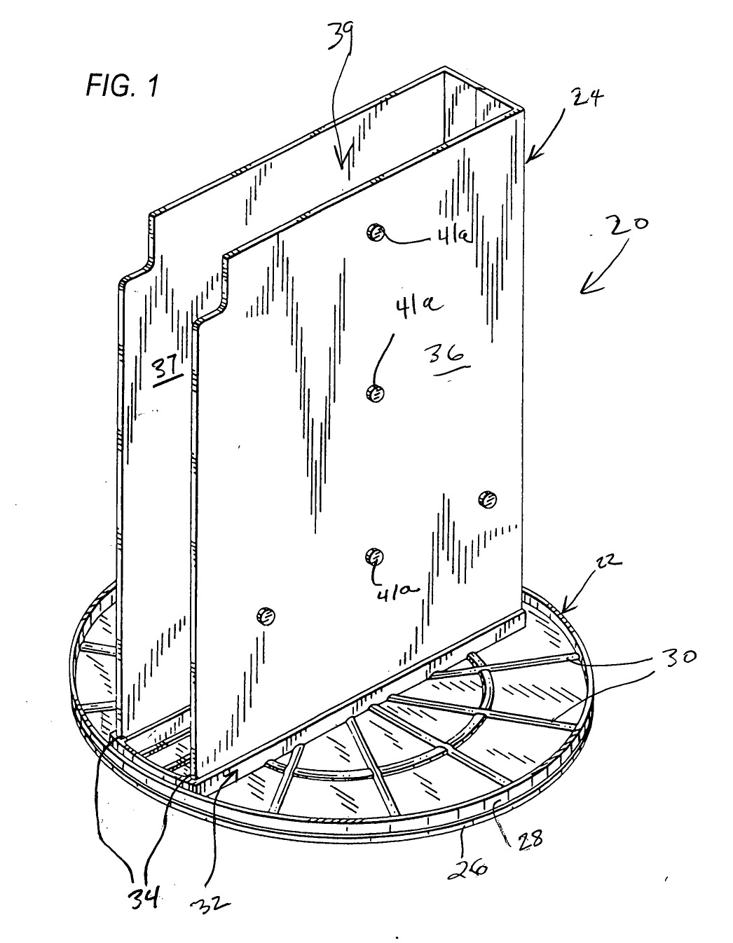

Referring to FIG. 1, organizer 20 comprises a base 22 and an anchor 24 extending upwardly therefrom. As described in more detail herein, components useful in various environments may be attached to anchor 24. Organizer 20 is shown in FIGS. 1-6 and 9 as including one anchor, but other embodiments may include more than one anchor.

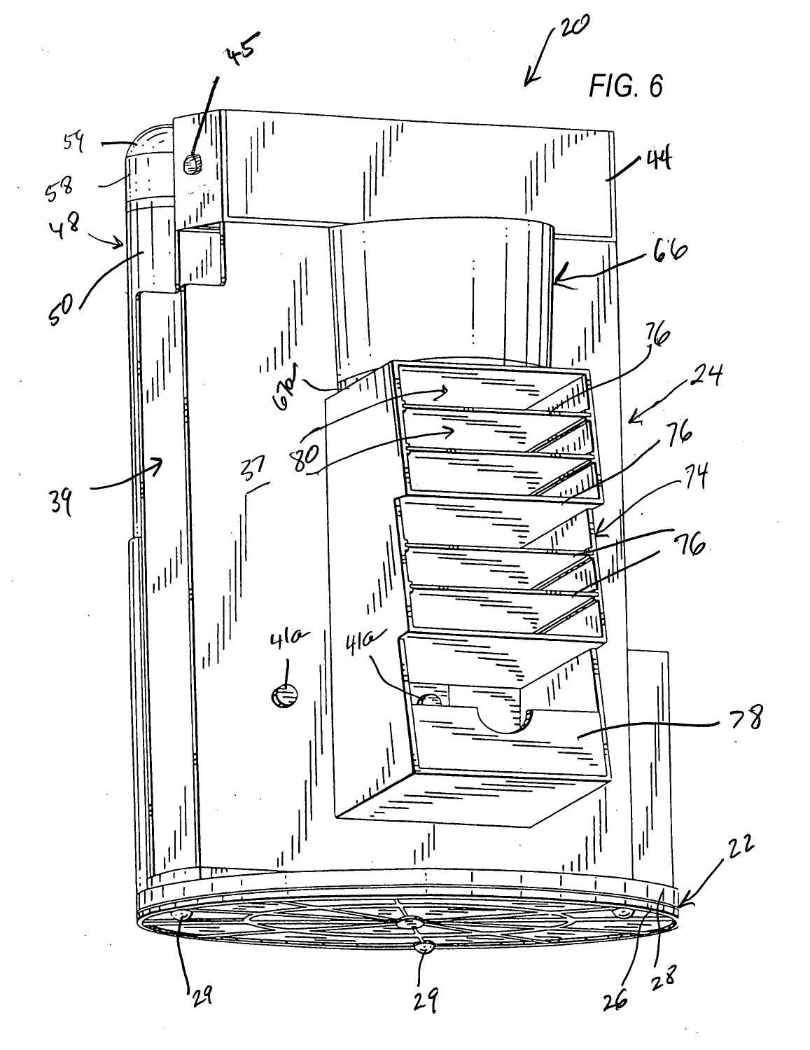

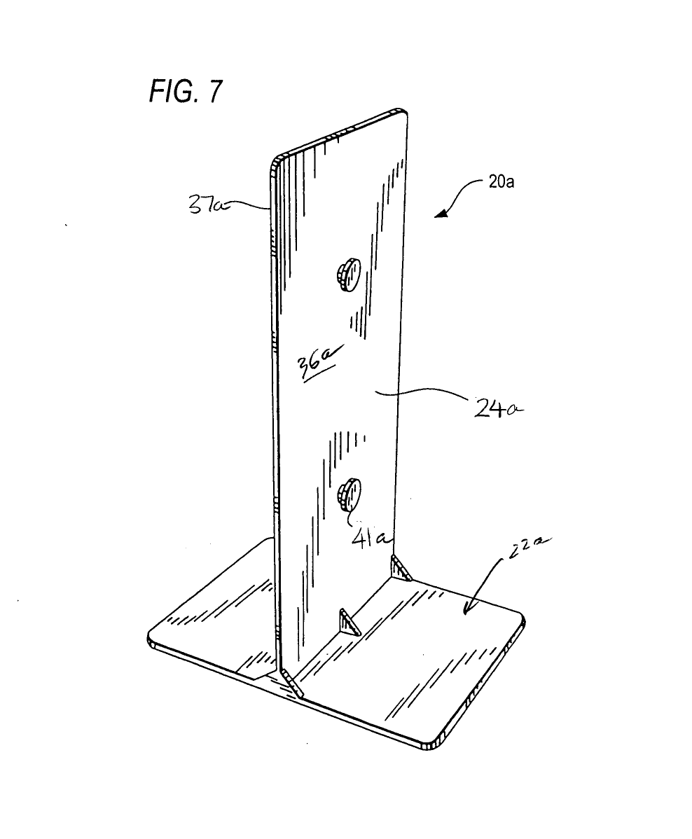

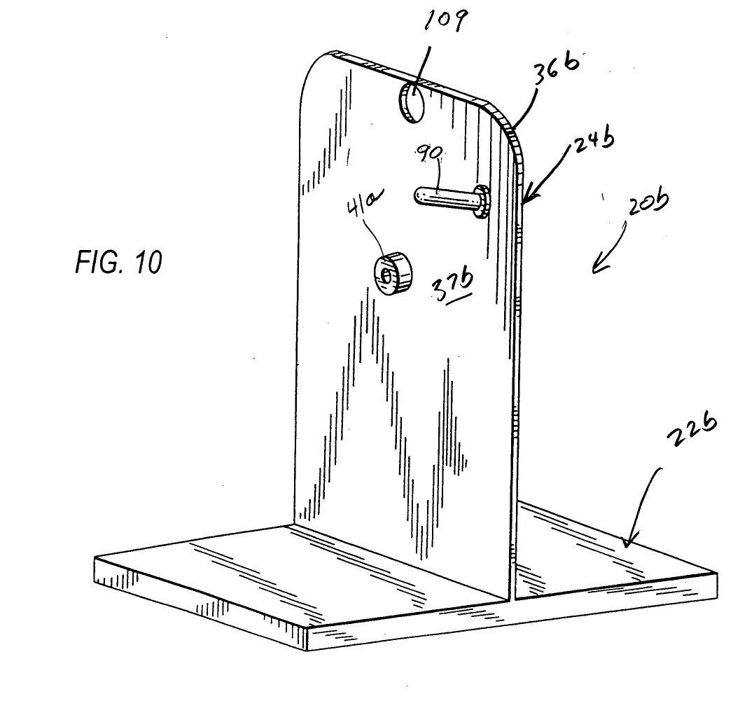

In the embodiment depicted in FIGS. 1-6 and 9, the anchor 24 and components mounted thereto are rotatable relative to a supporting structure such as a counter or desktop. Such rotatability is provided in the embodiment depicted in FIG. 1 by a two-part base. Base 22 comprises a lower part 26 and an upper part 28 rotatably mounted thereto. Lower base part 26 supports organizer 20 on a flat surface such as a counter top, shelf, desk or table, and upper part 28, to which the anchor 24 is mounted, rotates relative to lower base part 26. Non-skid feet 29 (FIG. 6) or other means may be provided on the bottom of the lower part of the base to prevent the organizer from easily moving or sliding on a flat surface. Any suitable arrangement may be used to rotatably mount the upper base part 28 to the lower base part, e.g., in Lazy Susan fashion. The organizer embodiment depicted in FIG. 1, which includes an rotatable anchor, comprises a circular base which facilitates rotatability and in many instances optimizes use of available space on a countertop or desk, etc., but other shapes and configurations may also be suitable, e.g., as shown in FIGS. 7 and 10.

Rotatability of the anchor 24 may also be provided by a base that itself is rotatable relative to a counter or desktop. Instead of attaching the anchor 24 to a base part that is rotatable relative to another base part, as in the embodiment of FIG. 1, the anchor 24 may be non-rotatably mounted to the base, and bearings or rollers may be mounted to the bottom of the base, or the bottom of the base may be provided with a low friction coating or legs, or made of a low friction material, e.g., Teflon, so that the base and anchor are rotatable as a unit.

The anchor 24 may be permanently or detachably attached to the base 22. Permanent attachment may be achieved by bonding the anchor 24 to the upper base part 28. Upper base part 28 includes a platform 32 comprising slots 34 that receive and in which anchor walls 36, 37 that extend upwardly, preferably vertically, are, e.g., bonded. Other means may be used to attach anchor 24 to base 22, e.g., clips, fasteners, various frictionally engagement arrangements, etc. Upper base part 28 preferably also includes ribs 30, e.g., radially-extending, for structural purposes. Embodiments of the organizer may include one or more of the same or different anchors for mounting components thereon.

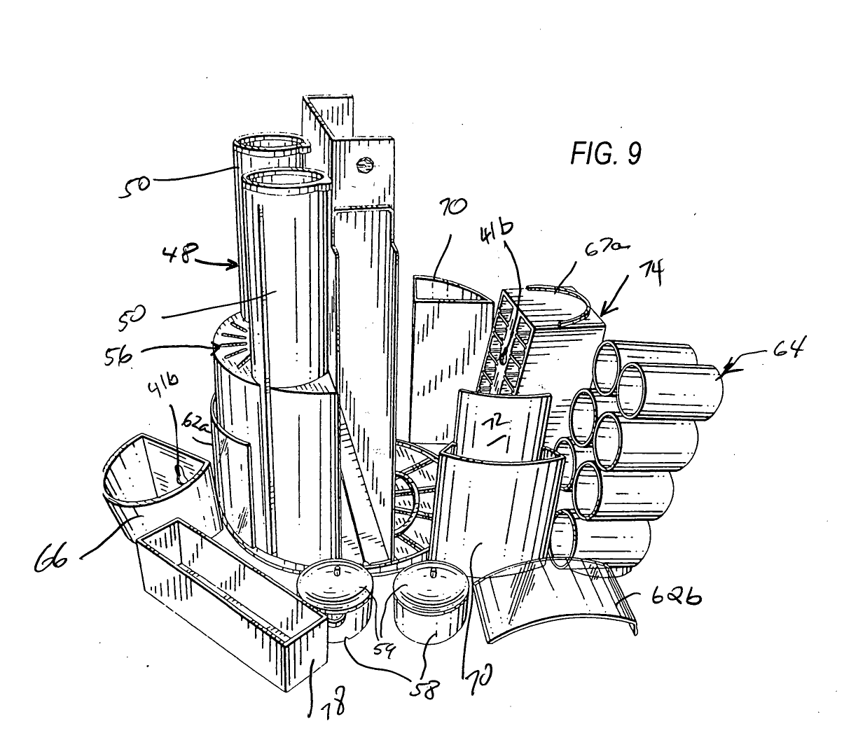

As shown in FIG. 1, anchor 24 includes a compartment or interior space 39, defined by walls 36, 37 and upper base part 28, which is open at the top and along one minor side (or along both minor sides, not shown). This space may be used for storing a variety of items, e.g., sheets of paper, pamphlets, a cutting board, or a book. Attached, preferably permanently, to the exterior major sides of the walls 36, 37 of the anchor 24, at preselected locations, are parts 41a of complementary or mating structures 41a, 41b (see FIG. 9). Such mating structures may comprise, in one embodiment, protrusions in the form of button-type elements 41a and receptacles in the form of keyholes 41b (FIG. 9). However, it is to be understood, as is well known to those skilled in the art, that a wide variety of complementary mating structures may be used. Such mating structures can comprise, for example, other protrusions (e.g., buttons, knobs, rods, pins) and receptacles such as pins that snap into and frictionally engage blind holes or receptacles, other snap fit arrangements, hook and fabric arrangements, latches, catches, fasteners (e.g., screws, bolts) etc., and other suitable mating or complementary structure and their equivalents.

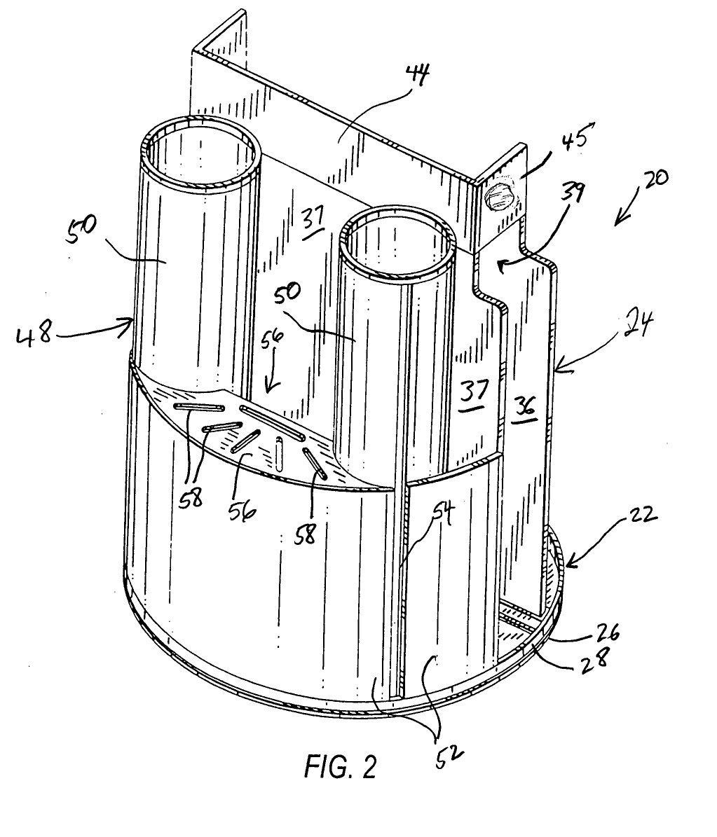

Referring to FIG. 2, on anchor top component 44 is attached to the top of the anchor 24. Top component (or “anchor top”) 44 includes a knob or similar structure 45 on opposite minor sides thereof for detachably attaching a carrying strap or handle (not shown). The strap or handle can be fabricated of any material, such as ballistic nylon, leather, or other material and attached to the anchor top 44. For greater stability, the anchor top 44 may be permanently attached to the anchor, e.g., bonded thereto, when ribs or other structure is provided to attach a carrying strap or handle. A complementary structure (not shown) such as a button hole is provided on the handle to engage with structure 45 to detachably mount the handle to the anchor top. Alternatively, a handle can be mounted to the anchor itself, and a handle could be permanently attached. A strap or handle (FIG. 9) may be used to carry or transport the organizer either within or between premises. In applications where greater height of a particular anchor is desired, the anchor top 44 may be detachably mounted, e.g., by nesting, to the anchor 24.

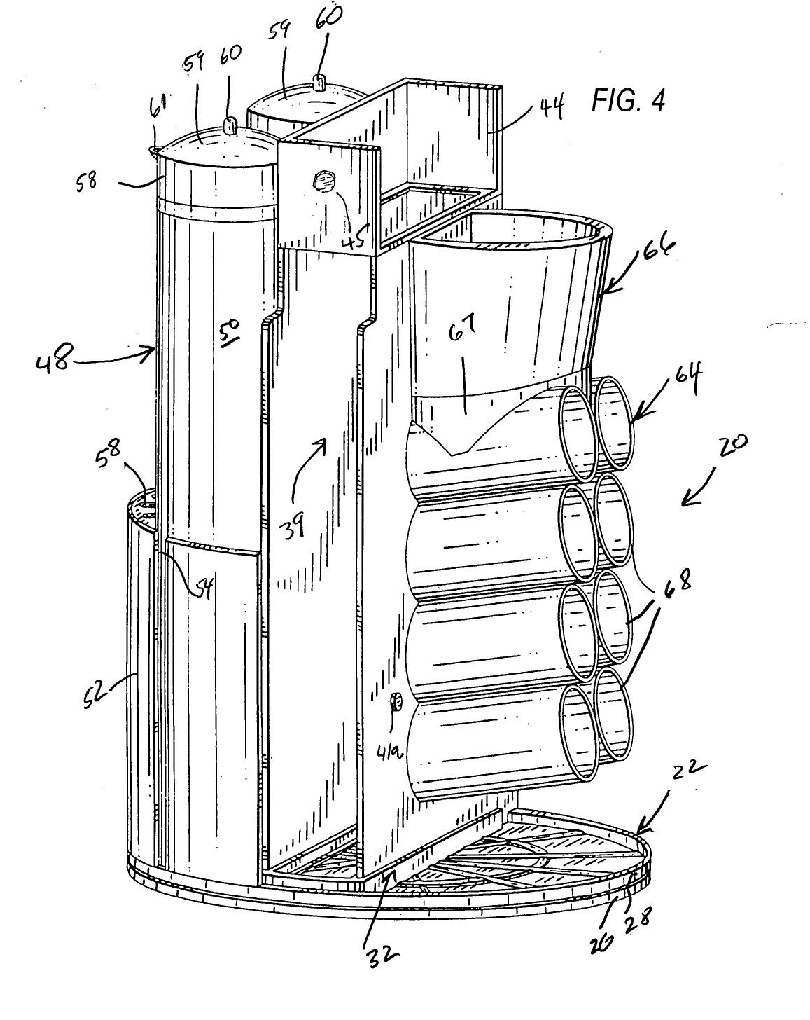

Referring to FIGS. 2-6 and 9, components (e.g., a foil holder component 48) may be permanently or removably attached to the anchor 24. Such components may be provided for specific or general application use with one or more organizers that are provided for particular or general application environments. Various embodiments of the organizers provide for interchangeable use of various components. For example, organizer 20 with the foil holder component, or simply, “foil holder” 48, depicted in FIG. 2 is useful as a kitchen organizer. Additional components depicted in FIGS. 4-6 and 9 are also useful for a kitchen environment.

Foil holder 48 (FIG. 2) includes tubes 50 which may be used, for example, as dispensers for plastic wrap, aluminum foil or the like. A peripheral wall 52 extends from one edge of wall 37 of anchor 24 around tubes 50. A vertical slot 54 is provided in the wall 52 adjacent each tube 50 for guiding the contents of the respective tube outward. The edge of each slot 54 may function also as a cutting edge.

The foil holder component 48 includes a knife holder 56 defined by a space between the outer wall 52 of the foil holder and the wall 37 of the anchor between the tubes 50 closed by an upper wall 56 in which slots 58 are provided for holding knives.

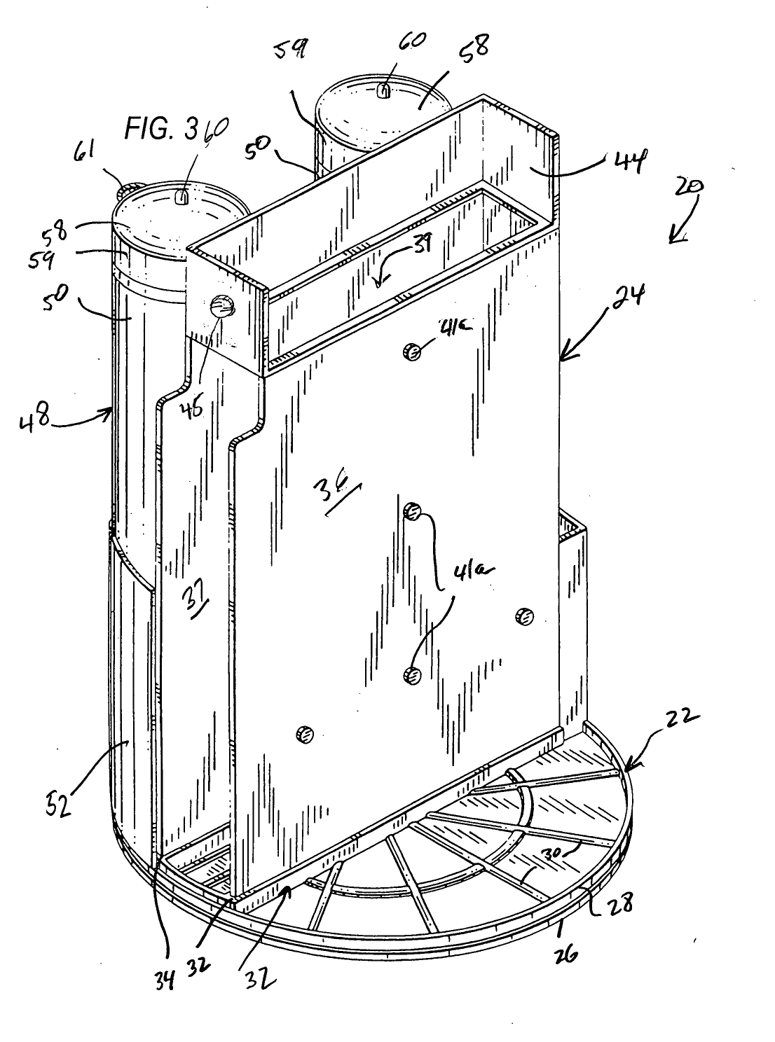

Referring to FIG. 3, lids 58 may be provided for closing the tops of tubes 50. The lids 58 in this embodiment nest in the top of the respective tube. Lids 58 may simply close off the tops of tubes 50. However, in the embodiment depicted in FIG. 3, the lids 58 nest in containers 59 which nest in the tops of tubes 50. The containers 59 may hold bulk material such as sugar, salt, pepper, flour, etc. The containers 59 and lids 58 are removable as a unit, with the lids 58 then being removable from the containers 59, e.g., for refilling the containers. Tabs 60 are provided to facilitate removal and replacement. For convenience, a lid/container 58/59 includes a spout 61 to facilitate dispensing the bulk material.

In an alternative embodiment, the tubes 50 may function as containers for bulk materials. In that embodiment, the lids close the tops of the tubes which may be provided with a respective closable opening near the bottom for facilitating dispensing of the bulk materials.

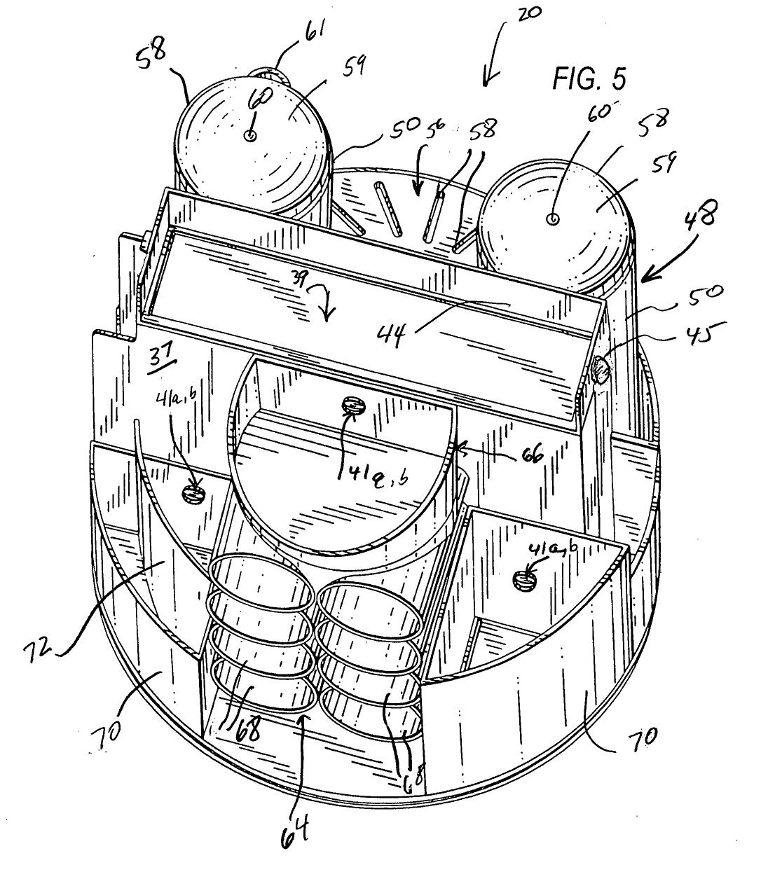

FIGS. 4 and 5 show several components 64, 66 and 70, in addition to foil holder 48, detachably attached to the anchor 24 using the mating structures 41a, 41b. A spice rack 64 is attached to the side of the anchor 24 opposite to the side to which the foil holder 48 is attached, and a bin 66 is attached above the spice rack 64. Both are attached to anchor 24 by mating structures 41a, 41b, and the top of the spice rack includes an extension 67 (FIG. 4) which fills in the space between the top of the spice rack and the bottom of the bin, and assists in supporting/stabilizing the bin. Spice rack 64 includes tubular, laterally extending receptacles 68 for holding spice jars and the like. Wedge shaped bins 70 (FIG. 5) may be provided on one or both sides of the spice rack 64, either or both of which may be divided by divider walls 72. The bins 66, 70 may be used to hold small items such as meat thermometers, bottle openers, and the like.

Referring to FIG. 6, a recipe rack 74 is attached to anchor 24 in place of the spice rack 64 using mating structures 41a, 41b. The recipe rack 74 defines an interior space, which is subdivided by removable divider walls 76 and a drawer 78. The compartments 80 formed by the divider walls 76, and the drawer 78 may be used for holding recipes and other items. Bin 66 may be attached to the anchor 24 above the recipe rack 74 similar to the attachment thereof above the spice rack 64. The spice rack 74 also includes an extension 67a at the top thereof which assists in supporting/stabilizing the bin 66.

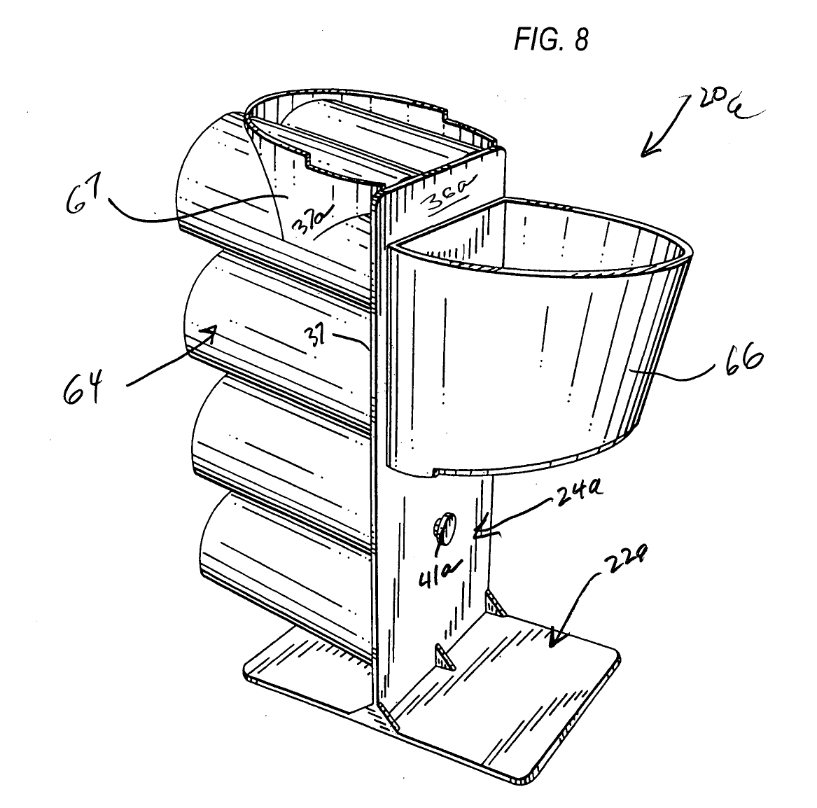

Referring to FIGS. 7 and 8, an accessory organizer or stand 20a is depicted which may be used for holding components that are mountable to another organizer such as organizer 20. The stand 20a may function as a mini-organizer, either as a stand-alone or as a complement to a larger organizer, or as a storage device to hold components for a larger or other organizer when not in use. Stand 20a comprises an upwardly extending panel or anchor 24a having major sides 36a, 37a. This panel is simplified as compared to the composite anchor of organizer 20 (FIG. 1). Stand 20a comprises a base 22a from which the panel 24a vertically extends. In the embodiment depicted in FIG. 7, the anchor 22a and the base 24a constitute a unitary, one-piece part, e.g., a unitary, integral molded piece, but may be fabricated from a base 22a and a panel or sheet 24a attached together. In the embodiment depicted in FIG. 7, the base 22a is rectangular and of a non-rotating type, and may include non-skid feet (e.g., feet 29 in FIG. 6) or other means on the bottom thereof to prevent the organizer from easily moving or sliding on a flat surface.

Referring to FIG. 8, the spice rack 64 and the bin 66 are detachably mounted to the stand 20a. Spice rack 64 is mounted to side 36a of the anchor 24a, and bin 66 is mounted to the side 37a of the anchor, as mentioned, either for temporary storage of an organizer, or for active use as an extension of or complement to the organizer.

As discussed above, many components may be detachably mounted to an organizer or a stand, e.g., organizer depicted in FIGS. 1-6 or stand depicted in FIGS. 7 and 8. Organizer 20 is depicted in FIG. 9 with the foil holder 48 attached thereto and surrounded by an assortment of other components that may be attached to the organizer. The component assortment depicted in FIG. 9 is exemplary only, and other components that are not shown may be provided for attachment to organizer and/or stand. The assortment depicted in FIG. 9 includes: bins 66, 70, drawer 78, lid containers/bins 58/59, frame 62b which attaches to frame base 62a which may be used to store photographs, cards or other similarly sized and shaped, thin and flat items, spice rack 64, and recipe rack 74. Organizers 20, 20a depicted in FIGS. 1-9 are exemplary of a kitchen organizer, and other configurations and components may be provided for kitchen organizers.

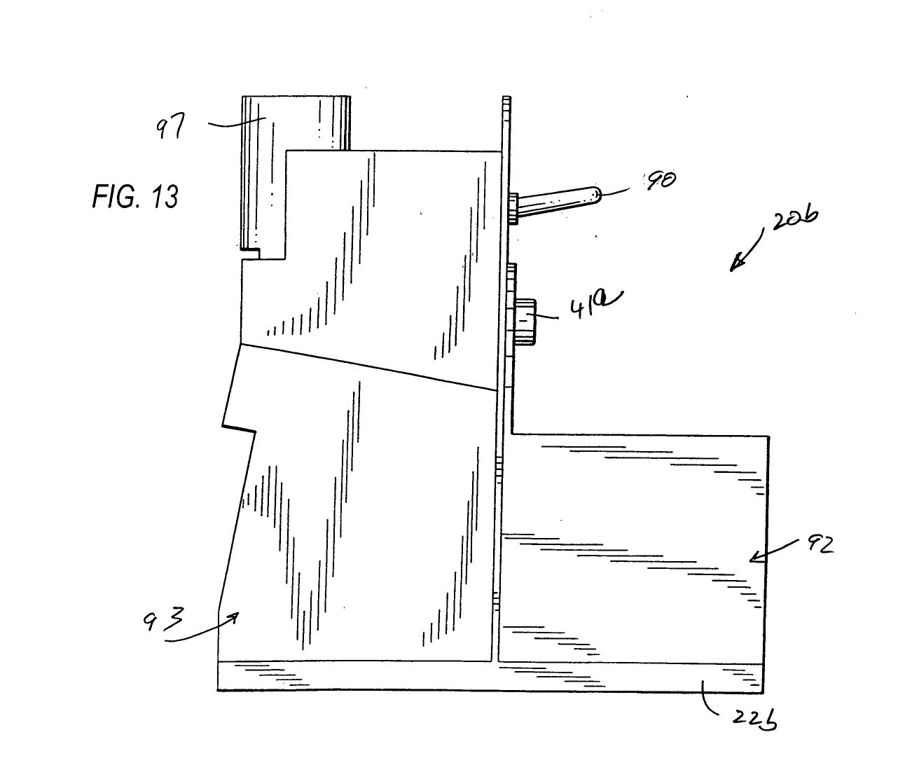

Referring to FIGS. 10-14, organizer 20b includes a base and an anchor that are similar in some respects to organizer 20a depicted in FIGS. 7-8. In this embodiment, similar to stand 20a depicted in FIG. 7, the anchor 20b comprises an upstanding panel or anchor 24b having opposed major sides 36b, 37b, which are provided with structure, such as 41a, for detachably mounting components. Similar to stand 20a depicted in FIG. 7, in this embodiment, the organizer 20b, the anchor 24b and the base 22b constitute a unitary, one-piece part, e.g., a unitary, integral molded piece. However, in other embodiments, the anchor can be attached (detachably or permanently) to the base after the anchor and base have been provided. In the embodiment depicted in FIG. 10, similar to stand 20a depicted in FIG. 7, the base is rectangular and of a non-rotating type, and may include non-skid feet (e.g., feet 29 in FIG. 6) or other means on the bottom thereof to prevent the organizer from easily moving or sliding on a flat surface. The anchor 24b of organizer 20b (FIG. 10) may be provided with the base 24 of organizer 20 (FIG. 1), and the anchor 24 of organizer 20 (FIG. 1) may be provided with the base 22b of organizer 20b (FIG. 10), etc. Many variations and combinations of bases and anchors, which may have varying sizes, structure and configurations, are possible.

Base 22b of organizer 20b (FIG. 10) may be sized and/or configured so as to fit in or stand on any appropriate item. For example, the bottom of base 22b may form an enclosure or cover that fits over a tissue box or other item, or the base 22b may be sized to nest in a particular item, etc.

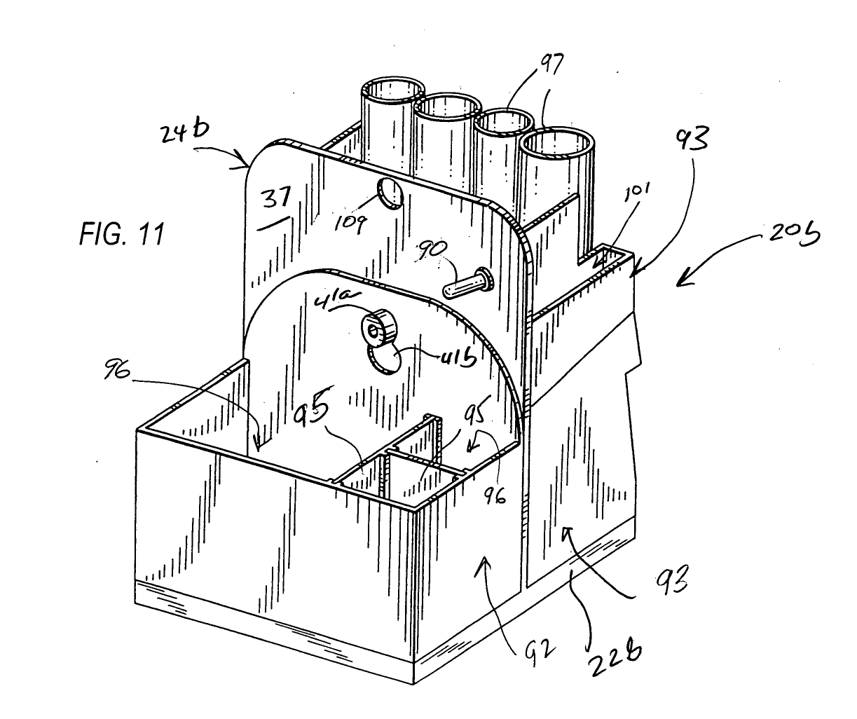

The structure for detachably mounting components to organizer 20b comprises buttons 41a, and pins or hooks 90. As pointed out above, other suitable structures may be used. Referring to FIGS. 11-14, keyholes 41b on respective components such as multi-section bins 92 and 93 mate with respective buttons 41b to detachably mount the bins 92, 93 to the anchor 24b. Bins 92 and 93 may also rest on the base 22b.

Bin 92 includes partitions 95 (FIGS. 5, 11 and 12) that define rectangular compartments 96 accessible from the top of the bin. The partitions may be adjustable to provide adjustable compartments. In an organizer for an office, bathroom, kitchen, garage, supply room, baby changing table, or other environment or multipurpose use, these compartments may be used for paper clips, keys, pens, pencils, rolls of stamps, small tools, cellular telephones, art materials, cosmetics, cotton swabs, bandages, medicine containers, vitamins or other storage items.

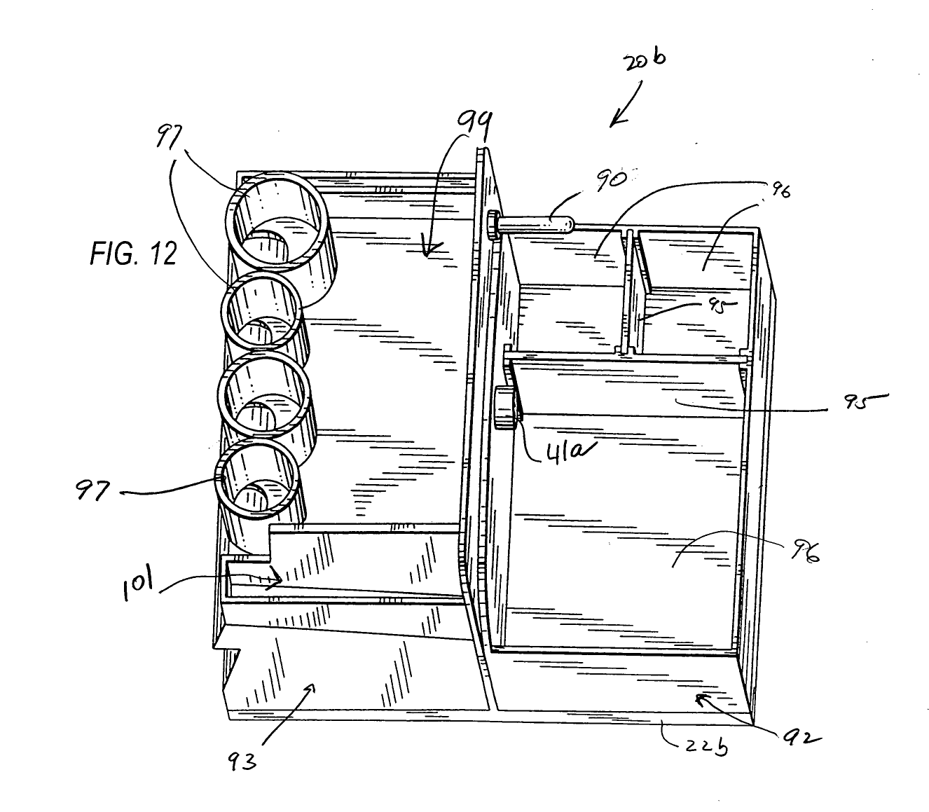

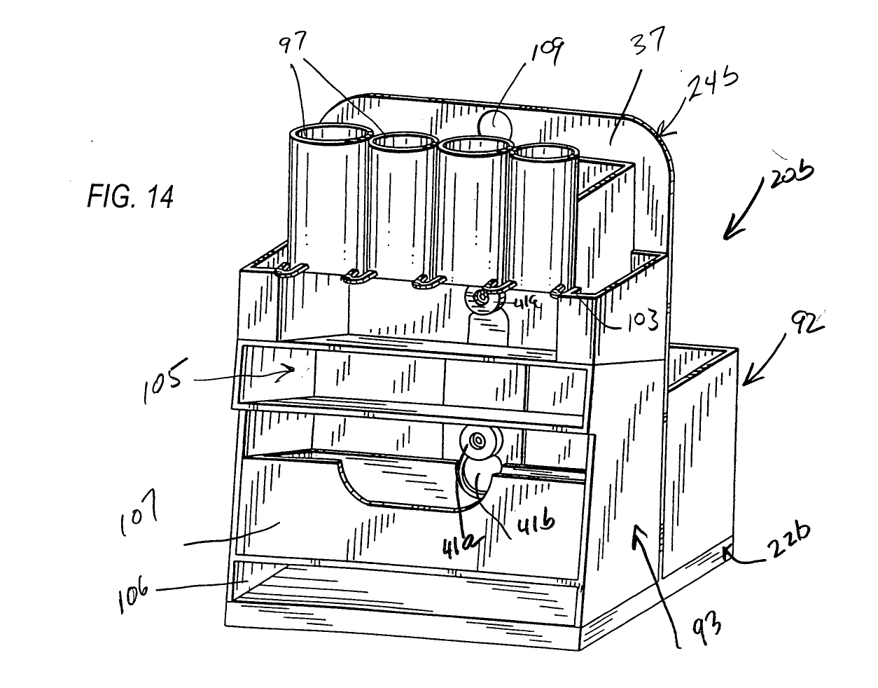

An upper portion of bin 93 (FIGS. 11-14) includes tubular compartments 97, a larger rectangular compartment 99 (FIG. 12) and a smaller rectangular compartment 101, all of which are accessible from the top of bin 93. In an organizer, e.g., for a kitchen or desk, tubular compartments 97 may be provided to store coins or paper clips or other fasteners, and rectangular compartments 99, 101 may be provided to store a note pad, recipe cards, playing cards, etc. As illustrated in FIG. 14, bin 93 also includes compartments 105, 106 accessible from the front of bin 93 and a drawer 107 which opens in the front of bin 93. Compartments 105, 106 and drawer 107 may be used to store various items, e.g., index or recipe cards, photographs, paper clips, office supplies, keys, cellular telephones, art materials, cosmetics, cotton swabs, bandages, medicine containers, vitamins or other items.

Anchor 24b of organizer 20b includes a hole 109 (FIGS. 11-14) which may be positioned and configured to receive a handle for lifting the organizer, or may receive a hook or pin for hanging the organizer from a suitable structure. One or more of the pins or hooks 90 may be used to hang a variety of items such as keys, rings, other modular components, or other items.

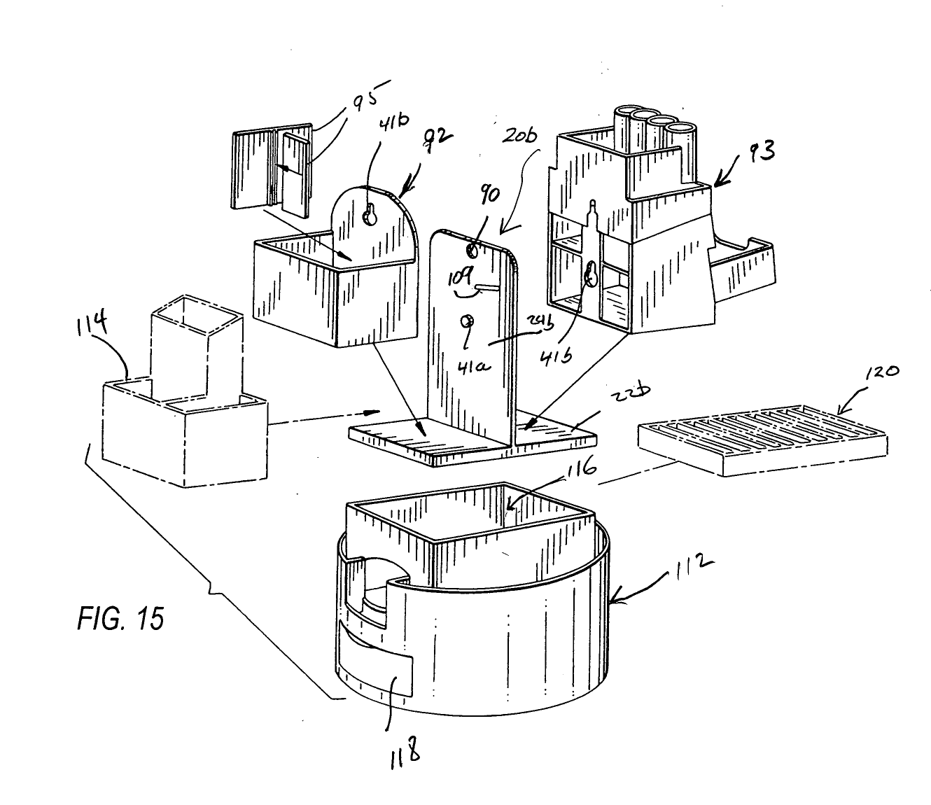

Organizer 20b may also function as an anchor and be attached to a separate base. The same applies to organizer or stand 20a. In such an embodiment, one of which is illustrated on FIG. 15, the reference 20b denotes an anchor including a base, e.g., laterally extending, portion 22b and an anchor, e.g., upwardly extending, portion 24b. The anchor 20b is attached to a base 112, in this embodiment, detachably. Base 112/anchor 20b may be made relatively rotatable, as described above, for example.

In the embodiment illustrated in FIG. 15, the laterally extending base portion 22b nests in a compartment 116, which may also house, for example, an item such as a tissue box, or items such as napkins, or other items. Detachable components are mounted to the upwardly extending anchor portion 24b. The upper part of compartment 116 may be provided with a lip (not shown) to receive and engage the laterally extending base portion 22b. Organizer or stand 20a may similarly function as an anchor.

As discussed above in connection with organizer 20 depicted in FIGS. 1-6 and organizer or stand 20a depicted in FIGS. 7 and 8, many components may be detachably mounted to an organizer. This applies as well to organizer or anchor 20b depicted in FIGS. 11-14. The organizer or anchor 20b may detachably receive an assortment of components, e.g., bins 92, 93 described above in connection with FIGS. 11-14 (and bin 114 shown in broken lines). The compartments of bin 114 may be configured to store, e.g., CDs DVDs, tapes, etc. The component assortment depicted in FIG. 15 is also exemplary only, and other components that are not shown may be provided for attachment to organizer and/or base. The base 112 may include a central storage area 116 for receiving, e.g., a tissue box or larger items, and one or more drawers 118 or other storage compartments for storing various items. Thus, the compartment 116 may receive a tissue box, as discussed above, and receive the lateral portion 22b of anchor 20b. Alternatively, the compartment 116 may receive a tray 120, for example, with compartments for receiving, e.g., jewelry items or keys, may nest in the upper part of compartment 116 instead of an anchor.

While the invention has been described and illustrated in connection with preferred embodiments, many variations and modifications, as will be apparent to those of skill in the art, may be made without departing from the spirit and scope of the invention. For example, suitable structure in addition to that illustrated and described may be used to detachably mount components to anchors or to each other, or to additional bases, etc. Also, organizers may be used in many environments to hold or organize many items. Further, components other than those illustrated may be used for various environments. Therefore, the specific embodiments illustrated in the drawings were meant to be exemplary and not limiting, and other organizers for the described and other environments may be provided using the principles of the invention disclosed herein. The invention as set forth in the appended clams is thus not limited to the precise details of construction set forth above as such variations and modifications are intended to be included within the spirit and scope of the invention as set forth in the claims.

What is claimed is:

1. A customizable organizer, comprising:
a base;
an anchor attached to the base;
a plurality of components for detachable mounting to the anchor, each component being useful for holding at least one item;
the anchor, each of the components, or both, including structure unitary to the anchor, the respective component or both, or attached thereto, which functions to detachably mount, or assisting in detachably mounting, a respective component to the anchor.

2. The organizer of claim 1 wherein the structure comprises a projection and a receptacle that releaseably engage.

3. The organizer of claim 1 wherein the base and the anchor are permanently attached.

4. The organizer of claim 1 wherein the anchor is mounted so as to rotate with respect to at least a portion of the base.

5. The organizer of claim 4 wherein the base comprises an upper and a lower disc-shaped panel, the anchor being attached to the upper panel, and the upper and lower panels being rotatably mounted together.

6. The organizer of claim 1, wherein the plurality of components comprises at least two of the following:
a component including at least one tube which, when this component is mounted to the anchor, extends upwardly and is suitable for receiving and dispensing foil from a tube thereof;
a component for holding a plurality of knives including slots suitable for receiving blades of the knives;
a component for holding tubular containers including a plurality of tubular compartments, each compartment extending laterally and/or upwardly when this component is mounted to the anchor;
a component configured and sized to hold a plurality of discrete items which extends laterally and/or upwardly when this component is mounted to the anchor;
a component configured and sized to hold bulk material which extends upwardly when this component is mounted to the anchor;
a component comprising a plurality shelves, each shelf extending laterally when this component is mounted to the anchor;
a component comprising at least one drawer which extends laterally when this component is mounted to the anchor;
a component mountable to the anchor that is configured and sized to hold thin and flat objects;
a component mountable to the anchor that comprises an electronic device; and
a component including at least one closable container which is suitable for holding bulk material and which, when this component is mounted to the anchor, extends upwardly.

7. The organizer of claim 1 wherein the anchor is elongated and extends upwardly from the base.

8. The organizer of claim 7 wherein the anchor includes spaced walls defining an interior space suitable for storage of at least one item therein.

9. The organizer of claim 1 wherein the anchor includes a lateral portion and a portion which extends upwardly from the lateral portion when the anchor is mounted to the base, the plurality of components being detachably mountable at least to the upwardly extending portion of the anchor.

10. The organizer of claim 1 comprising a handle attached to the anchor for carrying the organizer.

11. The organizer of claim 10 wherein the handle is detachably attached to the anchor.

12. A customizable organizer, comprising:
a base;
an elongated anchor attached to the base extending upwardly therefrom;
a plurality of components for detachable mounting to the anchor, each component being useful for holding at least one item;
the anchor and each of the components including structure unitary to the anchor and the respective component which function to detachably mount a respective component to the anchor.

13. The organizer of claim 12 wherein the structure comprises a projection and a receptacle that releaseably engage.

14. The organizer of claim 12 wherein the base and the anchor are permanently attached.

15. The organizer of claim 12, wherein the plurality of components comprises at least two of the following:
a component including at least one tube which, when this component is mounted to the anchor, extends upwardly and is suitable for receiving and dispensing foil from a tube thereof;
a component for holding a plurality of knives including slots suitable for receiving blades of the knives;
a component for holding tubular containers including a plurality of tubular compartments, each compartment extending laterally and/or upwardly when this component is mounted to the anchor;
a component configured and sized to hold a plurality of discrete items which extends laterally and/or upwardly when this component is mounted to the anchor;
a component configured and sized to hold bulk material which extends upwardly when this component is mounted to the anchor;
a component comprising a plurality shelves, each shelf extending laterally when this component is mounted to the anchor;
a component comprising at least one drawer which extends laterally when this component is mounted to the anchor;
a component mountable to the anchor that is configured and sized to hold thin and flat objects;
a component mountable to the anchor that comprises an electronic device; and
a component including at least one closable container which is suitable for holding bulk material and which, when this component is mounted to the anchor, extends upwardly.

16. A customizable organizer, comprising:
a base;
an elongated anchor attached to the base extending upwardly therefrom, the anchor and base being a unitary and integral piece;
a plurality of components for detachable mounting to the anchor, each component being useful for holding at least one item;
the anchor and each of the components including structure unitary to the anchor and the respective component which function to detachably mount a respective component to the anchor.

17. The organizer of claim 16 wherein the structure comprises a projection and a receptacle that releaseably engage.

18. The organizer of claim 16, wherein the plurality of components comprises at least two of the following:
a component including at least one tube which, when this component is mounted to the anchor, extends upwardly and is suitable for receiving and dispensing foil from a tube thereof;
a component for holding a plurality of knives including slots suitable for receiving blades of the knives;
a component for holding tubular containers including a plurality of tubular compartments, each compartment extending laterally and/or upwardly when this component is mounted to the anchor;
a component configured and sized to hold a plurality of discrete items which extends laterally and/or upwardly when this component is mounted to the anchor;
a component configured and sized to hold bulk material which extends upwardly when this component is mounted to the anchor;
a component comprising a plurality shelves, each shelf extending laterally when this component is mounted to the anchor;
a component comprising at least one drawer which extends laterally when this component is mounted to the anchor;
a component mountable to the anchor that is configured and sized to hold thin and flat objects;
a component mountable to the anchor that comprises an electronic device; and
a component including at least one closable container which is suitable for holding bulk material and which, when this component is mounted to the anchor, extends upwardly.

19. A customizable organizer, comprising:
a base;
an anchor comprising a base portion and an anchor portion extending upwardly from the base portion, the anchor portion and the base portion being a unitary and integral piece;
the anchor being mounted to the base;
a plurality of components for detachable mounting to the anchor, each component being useful for holding at least one item;
the anchor, each of the components, or both, including structure unitary to the anchor, the respective component or both, or attached thereto, which functions to detachably mount, or assisting in detachably mounting, a respective component to the anchor.

20. The organizer of claim 19, wherein the plurality of components comprises at least two of the following:
a component including at least one tube which, when this component is mounted to the anchor, extends upwardly and is suitable for receiving and dispensing foil from a tube thereof;
a component for holding a plurality of knives including slots suitable for receiving blades of the knives;
a component for holding tubular containers including a plurality of tubular compartments, each compartment extending laterally and/or upwardly when this component is mounted to the anchor;
a component configured and sized to hold a plurality of discrete items which extends laterally and/or upwardly when this component is mounted to the anchor;
a component configured and sized to hold bulk material which extends upwardly when this component is mounted to the anchor;
a component comprising a plurality shelves, each shelf extending laterally when this component is mounted to the anchor;
a component comprising at least one drawer which extends laterally when this component is mounted to the anchor;
a component mountable to the anchor that is configured and sized to hold thin and flat objects;
a component mountable to the anchor that comprises an electronic device; and
a component including at least one closable container which is suitable for holding bulk material and which, when this component is mounted to the anchor, extends upwardly.
